(19) United States
(12) Patent Application Publication
(10) Pub. No.: US 2026/0186988 A1
(43) Pub. Date: Jul. 2, 2026

(54) BUFFER CHIP FOR ROUTING COMMAND/ADDRESS AND DATA SIGNALS TO A STACK OF MEMORY DIES WITHIN A MEMORY SYSTEM

(71) Applicant: Micron Technology, Inc., Boise, ID (US)

(72) Inventors: Gang Zhao, Boise, ID (US); Aparna U. Limaye, Boise, ID (US)

(21) Appl. No.: 19/426,163

(22) Filed: Dec. 19, 2025

Related U.S. Application Data
(60) Provisional application No. 63/740,077, filed on Dec. 30, 2024.

(51) Int. Cl. G06F 13/16

(52) U.S. Cl. CPC G06F 13/1668; G06F 2213/16

(57) ABSTRACT

Methods, systems, and devices for a buffer chip for routing command/address (CA) and data signals to a stack of memory dies within a memory system are described. The described techniques provide for a buffer chip included within a memory package and coupled with multiple stacked memory dies of the memory package. The buffer chip may include circuitry configured to receive both CA signals and data signals and route the data signals to respective target memory dies within a package. A command may include one or more CS signals and a set of CA bits, where a portion of the set of CA bits may indicate a chip identifier (CID). The buffer chip may determine which memory die within the package to route a data signal according to a combination of the one or more CS signals and the CID.

### CROSS REFERENCE

The present Application for Patent claims priority to U.S. Patent Application No. 63/740,077 by Limaye et al., entitled “BUFFER CHIP FOR ROUTING COMMAND/ADDRESS AND DATA SIGNALS TO A STACK OF MEMORY DIES WITHIN A MEMORY SYSTEM,” filed Dec. 30, 2024, which is assigned to the assignee hereof, and which is expressly incorporated by reference in its entirety herein.

### TECHNICAL FIELD

The following relates to one or more systems for memory, including a buffer chip for routing command/address (CA) and data signals to a stack of memory dies within a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports a buffer chip for routing command/address (CA) and data signals to a stack of memory dies within a memory system in accordance with examples as disclosed herein.

FIG. 2 shows an example of a memory system that supports a buffer chip for routing CA and data signals to a stack of memory dies within a memory system in accordance with examples as disclosed herein.

FIG. 3 shows an example of a memory device that supports a buffer chip for routing CA and data signals to a stack of memory dies within a memory system in accordance with examples as disclosed herein.

FIG. 4 shows an example of a timing diagram that supports a buffer chip for routing CA and data signals to a stack of memory dies within a memory system in accordance with examples as disclosed herein.

FIG. 5 shows a block diagram of a memory system that supports a buffer chip for routing CA and data signals to a stack of memory dies within a memory system in accordance with examples as disclosed herein.

FIG. 6 shows a flowchart illustrating a method or methods that support a buffer chip for routing CA and data signals to a stack of memory dies within a memory system in accordance with examples as disclosed herein.

### DETAILED DESCRIPTION

Memory systems may support or otherwise be associated with operations for storing and retrieving data. For example, a memory system may include one or more arrays of memory cells configured to store data, and the memory system may access the one or more arrays of memory cells in accordance with commands received from a host system associated with the memory system. In some cases, the one or more arrays of memory cells may be located on one or more memory dies of the memory system, where the one or more dies may be stacked within a three-dimensional (3D) structure (e.g., to improve memory density at the memory system). The host system may access the stacked memory dies via a data bus and a chip select (CS) pin coupled with the stacked memory dies. For example, the host system may issue a command selecting a first set of stacked memory dies (e.g., via a CS signal) and accessing data (e.g., indicating data to be accessed in accordance with the command) associated with the first set of stacked memory dies (e.g., data to be read from or written to one or more of the first set of stacked memory dies). In some cases, each memory die may be individually connected with the data bus to receive or output data in response to an access command. However, a quantity of memory dies loaded on to (e.g., coupled with) the data bus may be correlated with capacitive loading at the data bus and the terminals of the memory dies, such that an increased quantity of memory dies coupled with the data bus may increase memory density, but may reduce signaling rate and signal integrity within the memory system. For example, accessing a relatively large quantity of memory dies via individual connections to the data bus may result in relatively large amounts of signal integrity degradation (e.g., due to reflections and crosstalk incurred by heavy loading, among other examples).

Techniques described herein provide for inclusion of a buffer chip within a memory package, where the buffer chip may be coupled with multiple stacked memory dies of the memory package and a data bus between the memory system and a host system. For example, a memory system may include multiple memory packages that each include a respective buffer chip that serves as an interface between the stacked memory dies of a corresponding memory package and a host system coupled with the memory system via a bus. The buffer chip may include circuitry configured to receive command/address (CA) signals and to transmit and receive data signals conveyed via one or more busses (e.g., a first command bus configured to carry CA bits, CS bits, and a clock signal and a second data bus configured to carry data bits), and to route the data signals to and from intended memory dies within a corresponding package according to the CA signals. For example, the host system may issue a command including one or more CS signals and a set of CA bits, where a portion of the set of CA bits (e.g., relatively higher order CA bits) may indicate a chip identifier (CID). The buffer chip may receive the one or more CS signals and the CID, and may determine which memory die within the package to route a data signal (e.g., included in or otherwise associated with the command) to and from according to a combination of the one or more CS signals and the CID. Such techniques may result in multiple stacked memory dies of a package being electrically isolated from a data bus while still receiving relevant commands and corresponding data via the buffer chip, thereby reducing capacitive load on the data bus and improving signaling rates and transfer speeds between the memory system and the host system. For example, the host system may observe a single capacitive load associated with the buffer chip, rather than a respective capacitive load associated with each memory die of a package.

In addition to applicability in memory systems as described herein, techniques for a buffer chip for routing CA and data signals to a stack of memory dies may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing capacitive load associated with accessing multiple packages including stacked memory dies, which may decrease processing or latency times, improve response times, or otherwise improve user experience, among other benefits.

In addition to applicability in memory systems as described herein, techniques for a buffer chip for routing CA and data signals to a stack of memory dies may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by improving response times associated with edge computing devices, among other benefits.

Features of the disclosure are illustrated and described in the context of systems and architectures. Features of the disclosure are further illustrated and described in the context of a memory device, a timing diagram, and flowcharts.

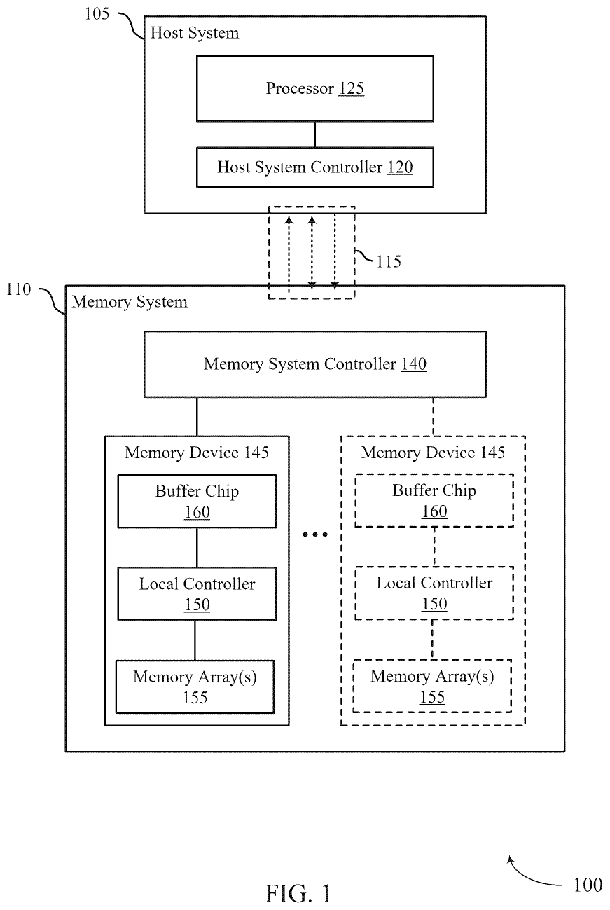

FIG. 1 shows an example of a system 100 that supports a buffer chip for routing CA and data signals to a stack of memory dies within a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof. Although illustrated as being included within the memory system 110 in FIG. 1, it is to be understood that, as described herein, a memory system controller 140 may be located within or coupled with the host system 105, the memory system 110, or both. Additionally, or alternatively, the memory system controller 140 may be coupled between the host system 105 and the memory system 110. For example, the memory system controller 140 may be an example of a registering clock driver (RCD) between the memory system 110 and the host system 105, an example of any other suitable controller, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not- or (NOR) memory cells, and not- and (NAND) memory cells, or any combination thereof.

A local controller 150 may include at least one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more CA channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A CA channel may be operable to communicate commands and addresses between the host system 105 and the memory system 110, including control information associated with the commands (e.g., address information, configuration information). Commands carried by a CA channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

In some examples of the system 100, the memory system 110 may include one or more memory arrays 155 located on one or more dies of the memory system, where the one or more dies may be stacked in a 3D structure (e.g., to improve memory density at the memory system 110). For example, such a stacked memory die structure may be included in a memory device 145 of the memory system 110 (e.g., each of the memory devices 145 in FIG. 1 may include two or more stacked dies). The host system 105 may access the stacked memory dies via a data bus (e.g., a channel 115) and a CS pin coupled with the stacked memory dies. For example, the host system 105 may issue a command selecting a first memory device 145 (e.g., via a CS signal) and accessing data associated with the first memory device 145 (e.g., data to be read from or written to one or more stacked memory dies of the first memory device 145). In some cases, each die may be individually connected with the data bus to receive or transmit data in response to an access command. However, a quantity of dies loaded on to (e.g., coupled with) the data bus may be correlated with capacitive loading at the data bus, which may limit signaling rate and signal integrity at the memory system 110. For example, accessing a relatively large quantity of dies via individual connections to the data bus may result in significant signal integrity degradation and performance degradation (e.g., due to reflections and crosstalk incurred by heavy loading).

Techniques described herein provide for a buffer chip 160 configured to be included within a memory package (e.g., a memory device 145) and coupled with multiple stacked dies of the memory package. For example, a memory system 110 may include multiple memory packages that each include a respective buffer chip 160 that serves as an interface between stacked memory dies of a corresponding memory package and the host system 105 or the memory system controller 140. The buffer chip 160 may be included in or otherwise coupled with the local controller 150 of a given memory device 145. The buffer chip 160 may include circuitry configured to receive both CA and data signals conveyed via one or more busses (e.g., a first channel 115 configured to carry CA bits, CS bits, and a clock signal and a second channel 115 configured to carry data bits), where the circuitry may route the data signals to intended memory dies within a corresponding memory device 145 according to the CA signals. For example, the host system 105 may issue a command including one or more CS signals and a set of CA bits, where a portion of the set of CA bits (e.g., relatively higher order CA bits) may indicate a CID. The buffer chip 160 may receive the one or more CS signals and the CID, and may determine which die within the memory device 145 to route a data signal (e.g., included in the command) to according to a combination of the one or more CS signals and the CID. Such techniques may result in multiple stacked dies of a memory device 145 being electrically isolated from a data bus, thereby reducing capacitive load on the data bus and improving signaling rates and transfer speeds between the memory system 110 and the host system 105. For example, the host system 105 may observe a single capacitive load associated with the buffer chip 160, rather than a respective capacitive load associated with each die of a package.

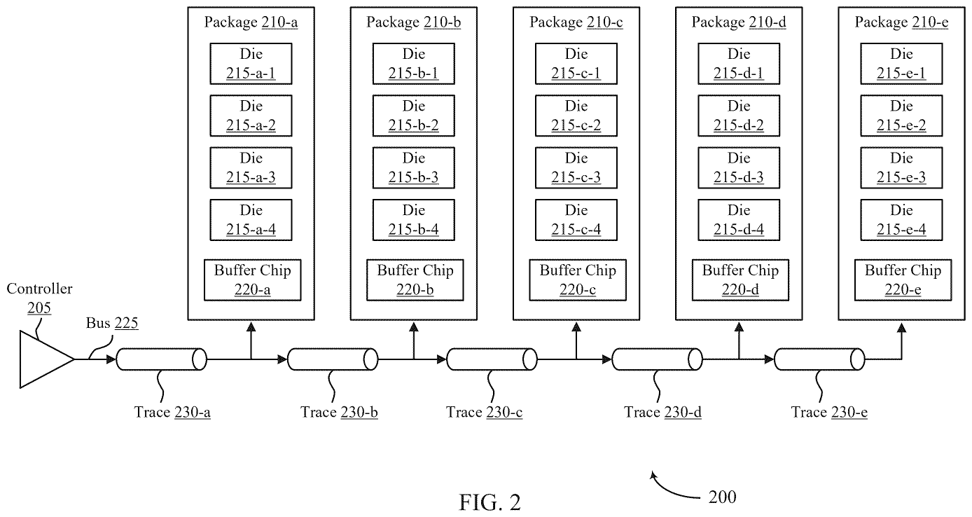

FIG. 2 shows an example of a memory system 200 that supports a buffer chip for routing CA and data signals to a stack of memory dies within a memory system in accordance with examples as disclosed herein. The memory system 200 may implement, or be implemented by, one or more aspects of the system 100. For example, the memory system 200 may be an example of the memory system 110 described with reference to FIG. 1. The memory system 200 illustrates a controller 205, which may be an example of a component included in or associated with the host system controller 120, the memory system controller 140, or both, as described with reference to FIG. 1. In some cases, the memory system 200 may include multiple packages 210 (e.g., a package 210-a, a package 210-b, a package 210-c, a package 210-d, and a package 210-e), where each package 210 may include a set of multiple stacked memory dies 215 and a buffer chip 220, which may represent an example of the buffer chip 160 described with reference to FIG. 1. As described herein, a package 210 may be an example of a memory device 145 described with reference to FIG. 1.

In some examples, a buffer chip 220 may couple with multiple dies 215 stacked within a corresponding package 210. For example, a buffer chip 220-a may couple with a die 215-a-1, a die 215-a-2, a die 215-a-3, and a die 215-a-4 of the package 210-a, a buffer chip 220-b may couple with a die 215-b-1, a die 215-b-2, a die 215-b-3, and a die 215-b-4 of the package 210-b, a buffer chip 220-c may couple with a die 215-c-1, a die 215-c-2, a die 215-c-3, and a die 215-c-4 of the package 210-c, a buffer chip 220-d may couple with a die 215-d-1, a die 215-d-2, a die 215-d-3, and a die 215-d-4 of the package 210-d, and a buffer chip 220-e may couple with a die 215-e-1, a die 215-e-2, a die 215-e-3, and a die 215-e-4 of the package 210-e. As described herein, one or more dies 215 included within the same package 210 (e.g., the same memory device) may be referred to as a logical rank and may be activated according to a given CS signal. For example, a value corresponding to one or more CS signals received in an access command may indicate a package 210 from the multiple packages 210 and may select a logical rank corresponding to the dies 215 of the indicated package 210. Alternatively, a logical rank may be associated with a level or layer of each die 215, such that each package 210 may include a die 215 associated with a respective rank. The techniques described herein may be applicable to either interpretation of a logical rank.

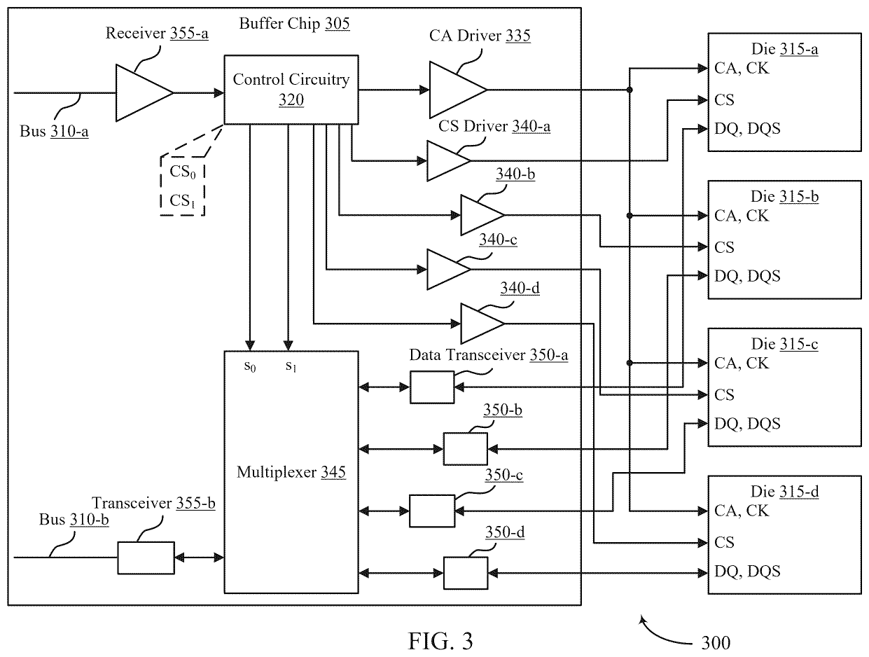

The buffer chip 220 may include circuitry configured to receive signals from a bus 225 and route the signals to the dies 215 of a corresponding package 210 (as described in greater detail with reference to FIG. 3). In some examples, the bus 225 may be an example of multiple data busses (e.g., channels 115 described with reference to FIG. 1) configured to convey various types of information to the memory system 200. For example, a first bus 225 may carry CA information, CS signals, a clock signal, or any combination thereof, and a second bus 225 may carry data signaling for the memory system 200. It should be noted that while the memory system 200 illustrates a single conductive line (e.g., the bus 225) coupling the memory system 200 with the host system (e.g., the controller 205), one of ordinary skill in the art will understand that multiple conductive lines may connect the memory system 200 with the host system corresponding to multiple busses for conveying the various types of information.

In some cases, the buffer chip 220 may be coupled with the bus 225 and may serve as an interface between the controller 205 and the set of dies 215 of a corresponding package 210. For example, the buffer chip 220 may include input/output (I/O) circuitry configured to receive CA information and data signals (e.g., associated with an access command received from the host system) associated with the corresponding package 210 from the bus 225. Additionally, the buffer chip 220 may include circuitry configured to route the CA information and the data signaling to the dies 215 of the corresponding package, which may support the buffer chip 220 accessing individual ones of the dies 215 (e.g., routing the data signaling to or from an intended die 215 according to the CA information).

In some examples, by including the buffer chip 220 in each package 210, each package 210 may be associated with a single respective trace 230 (e.g., a path or route, such as a PCB trace, between the controller 205 and a terminal of a buffer chip 220, where capacitive loading may occur). For example, the package 210-a may be associated with a trace 230-a, the package 210-b may be associated with a trace 230-b, the package 210-c may be associated with a trace 230-c, the package 210-d may be associated with a trace 230-d, and the package 210-e may be associated with a trace 230-e. Such techniques may reduce an overall capacitive load (e.g., observed by the host system) associated with accessing the dies 215 of the memory system 200, for example by reducing the terminal connections associated with each package 210 (e.g., reducing each package 210 to a respective trace 230). For example, without the buffer chip 220, each die 215 may be individually connected to the bus 225 via one or more respective pins (not pictured in FIG. 2). In such examples, to access twenty dies 215, the host system may observe twenty corresponding terminals from the dies 215 (e.g., one or more terminals per connection between the bus 225 and a die 215). Thus, by including the buffer chip 220 in each package 210, the host system (e.g., the controller 205) may observe five sets of one or more terminals from the five buffer chips 220 while still being capable of accessing twenty dies 215 (e.g., reducing the capacitive load from twenty to five). Due to the total quantity of terminal connections (e.g., associated with capacitive load) being correlated with signal integrity degradation (e.g., from reflections and crosstalk associated with complexity of the memory system 200) and reduction of transfer speed between the memory system 200 and the host system (e.g., and/or the controller 205), reducing the total quantity of terminal connections may improve overall performance of the memory system 200, particularly when transferring data associated with access commands received from the host system.

FIG. 3 shows an example of a memory device 300 that supports a buffer chip for routing CA and data signals to a stack of memory dies within a memory system in accordance with examples as disclosed herein. The memory device 300 may implement, or be implemented by, one or more aspects of the system 100 and the memory system 200. For example, the memory device 300 may be an example of a memory device 145 described with reference to FIG. 1 and a package 210 described with reference to FIG. 2. In some cases, the memory device 300 may include a buffer chip 305 coupled with one or more busses 310 and a set of multiple stacked dies 315, which may be examples of corresponding aspects described with reference to FIGS. 1 and 2. The memory device 300 illustrates a detailed view of circuitry included in the buffer chip 305 configured to receive CA information and data signals (e.g., from a host system via the busses 310) and route the data signals to and from individual ones of the dies 315 according to the CS information. It should be noted that the buffer chip 305 may include pins coupled between respective drivers and dies 315, such as pins located between electrical connections between drivers and the dies 315 as illustrated by the memory device 300.

The buffer chip 305 may be configured to receive a command from a host system indicating to access one or more dies 315 of the memory device 300 (e.g., a three-dimensional stacked (3DS) command). In some cases, the buffer chip 305 may receive CA information of the 3DS command via a bus 310-a. For example, the buffer chip 305 may receive, via the bus 310-a, a set of CA bits (e.g., CA[13:0]), one or more CS signals (e.g., CS[1:0], which may include a first CS signal and/or a second CS signal), a clock signal (e.g., an external clock associated with the host system, CK), or any combination thereof. In some cases, the buffer chip 305 may receive the CA information at a receiver 355-a. Additionally, or alternatively, the buffer chip 305 may receive and transmit data signals via a bus 310-b. For example, the buffer chip 305 may receive or transmit, via the bus 310-b, a data quality (DQ) signal, a DQ strobe (DQS) signal, or both indicating data information for accessing a die 315 (e.g., data to be written to the die 315 or data to be read from the die 315) of the memory device 300. In some cases, the buffer chip 305 may receive or transmit the data signals at a transceiver 355-b, which may additionally, or alternatively, serve as a driver or receiver of the buffer chip 305. As described herein, the receiver 355-a and the transceiver 355-b of the buffer chip 305 may be examples of I/O circuitry, and may be configured to receive signaling and information from the busses 310 (e.g., receive data as part of a write operation) and output signaling and information to the busses 310 (e.g., output data as part of a read operation).

The buffer chip 305 may be configured to input the CA information received via the bus 310-a from the receiver 355-a to control circuitry 320. In some cases, the control circuitry 320 may include a first-in-first-out (FIFO) queue, a decoder circuit, logic circuitry, or any combination thereof. The FIFO queue may be configured to buffer the received CA bits and the clock signal, and may input the CA bits and the clock signal to a CA driver 335. The CA driver 335 may be configured to forward the CA bits and the clock signal to a set of CA, CK pins at each die 315. For example, the CA driver 335 may forward the CA bits and the clock signal from a set of CA, CK pins of the buffer chip 305 to each individual memory die 315 (e.g., each memory die 315 may receive the CA bits and the clock signal included in the 3DS command). In some examples, the CA bits and the clock signal may be forwarded by respective drivers (e.g., the buffer chip may include a CK driver separate from the CA driver 335 and configured to forward the clock signal to each die 315). Additionally, or alternatively, the CA bits and the clock signal may be directly forwarded to the dies 315, for example without going through the control circuitry 320 (e.g., separate electrical connections may route the CA bits and the clock signal directly to the CA driver 335 as well as through the control circuitry 320).

In some examples, the CA information may include one or more CS signals. For example, the one or more CS signals may include a first CS signal, and the buffer chip 305 may receive the first CS signal at one or more CS pins of the buffer chip 305 (e.g., pins included in or associated with the control circuitry 320). In some cases, the buffer chip 305 may determine a die 315 of the memory device 300 being accessed by the 3DS command according to whether the first CS signal is received at a first CS pin (e.g., CS₀) or a second CS pin (e.g., CS₁) of the buffer chip. Additionally, the buffer chip 305 may determine the die 315 being accessed according to a CID signal included in the CA information. For example, a portion of the CA bits may indicate the CID signal (e.g., the CID may be indicated via CA [13:11]), and the decoder circuit of the control circuitry 320 may determine the die 315 being accessed based on a bit of the CID signal (e.g., CA13). In some cases, a combination of the CS pin receiving the first CS signal and the value of the CA13 bit may indicate which die 315 is being accessed by the 3DS command. For example, the decoder circuit may determine which die 315 is being accessed according to Table 1 below:

TABLE 1
Command-To-Die Mapping

| Input CA13 | Input CS | Output CS |
|---|---|---|
| 0 | CS₀ | CS_{die1} |
| 0 | CS₁ | CS_{die2} |
| 1 | CS₀ | CS_{die3} |
| 1 | CS₁ | CS_{die4} |

The decoder circuit may determine which die 315 is being accessed, and the logic circuitry may output a second CS signal to a CS driver 340 coupled with the die 315 that is being accessed. For example, if the die 315-a is being accessed, the logic circuitry may output the second CS signal to a CS pin of the die 315-a via a CS driver 340-a (e.g., CS_{die1} of Table 1), if the die 315-b is being accessed, the logic circuitry may output the second CS signal to a CS pin of the die 315-b via a CS driver 340-b (e.g., CS_{die2} of Table 1), if the die 315-c is being accessed, the logic circuitry may output the second CS signal to a CS pin of the die 315-c via a CS driver 340-c (e.g., CS_{die3} of Table 1), and if the die 315-d is being accessed, the logic circuitry may output the second CS signal to a CS pin of the die 315-d via a CS driver 340-d (e.g., CS_{die4} of Table 1). It should be noted that while the memory device 300 of FIG. 3 includes four dies 315, such techniques may support selection of greater quantities of dies 315, such as selecting between sixteen dies 315. In such examples of selecting greater quantities of dies 315, the decoder circuit may determine a die 315 according to multiple CS signals in the 3DS command (e.g., the 3DS command may include a third CS signal and values of both CS₀ and CS₁ may be used when determining the selected die 315), multiple bits in the CID signal (e.g., values of any of CA[13:11] may be used when determining the selected die 315), or any combination thereof.

In some examples, based on determining the die 315 being accessed by the 3DS command, the logic circuitry may output a selection signal to a multiplexer 345 of the buffer chip 305 (e.g., output values to selection pins s₀ and s₁ of the multiplexer 345). For example, after receiving the data signal at the transceiver 355-b via the bus 310-b, the transceiver 355-b may input the data signal to the multiplexer 345. Based on the value of the selection signal received by the logic circuitry, the multiplexer 345 may output the data signal (e.g., via a respective output of the multiplexer 345) to a data transceiver 350 coupled with the die 315 being accessed. For example, if the selection signal has a first value (e.g., a 0 at s₀ and a 0 at s₁), the multiplexer 345 may output the data signaling to a data transceiver 350-a to forward the data signaling to the die 315-a, if the selection signal has a second value (e.g., a 0 at s₀ and a 1 at s₁), the multiplexer 345 may output the data signaling to a data transceiver 350-b to forward the data signaling to the die 315-b, if the selection signal has a third value (e.g., a 1 at s₀ and a 0 at s₁), the multiplexer 345 may output the data signaling to a data transceiver 350-c to forward the data signaling to the die 315-c, and if the selection signal has a fourth value (e.g., a 1 at s₀ and a 1 at s₁), the multiplexer 345 may output the data signaling to a data transceiver 350-d to forward the data signaling to the die 315-d. It should be noted that values of the selection signal may be mapped to the dies 315 according to any suitable configuration, and the multiplexer 345 may include additional selection pins to support selection of greater quantities of dies 315 (e.g., three selection pins for selection between eight dies 315 or four selection pins for selection between sixteen dies 315).

In some examples, the buffer chip 305 may perform the access operation included in the 3DS command at the selected die 315 according to the CA bits, the clock signal, the second CS signal, and the data signaling. For example, if the 3DS command includes a write command indicating data to be written to the die 315-a, the buffer chip 305 may forward the data to the die 315-a (e.g., based on outputting the second CS signal and the data signaling to the die 315-a) for storage in one or more memory cells included in the die 315-a. As another example, if the 3DS command includes a read command indicating to retrieve data stored to the die 315-a, the buffer chip 305 may forward the CA signals to the die 315-a indicating address ranges associated with the requested data, and the die 315-a may output the requested data back to the buffer chip 305 (e.g., the data may be demultiplexed by the multiplexer 345 and output to the bus 310-b).

Such techniques may enable the buffer chip 305 to route a 3DS command to the dies 315 of the memory device 300 and select individual ones of the dies 315 for accessing, which may support the memory device 300 being associated with a single capacitive load at the bus 310-b, thereby improving signal integrity, transfer speeds, and overall performance of a memory system including multiple memory devices 300.

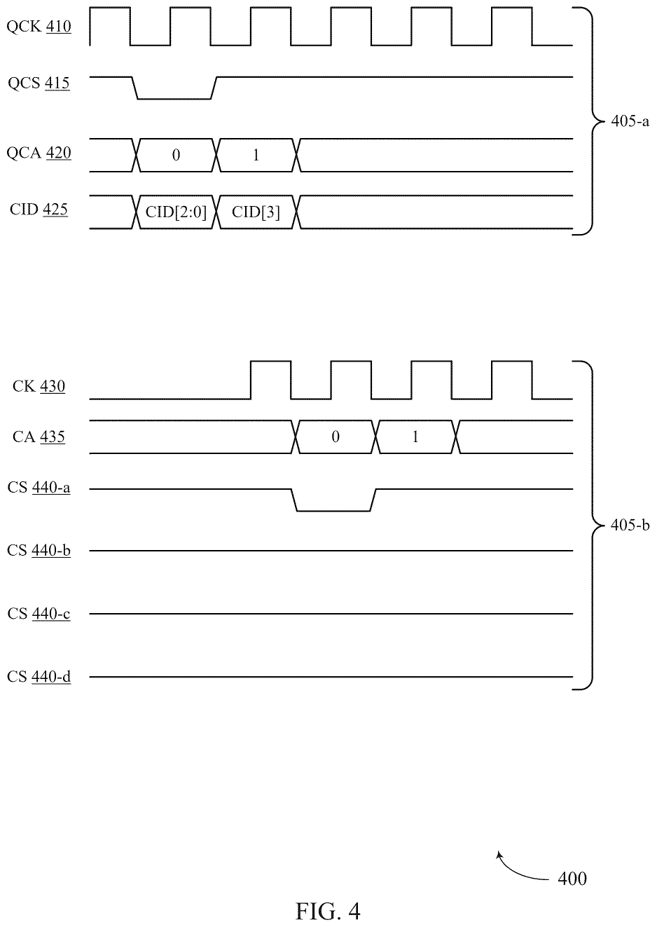

FIG. 4 shows an example of a timing diagram 400 that supports a buffer chip for routing CA and data signals to a stack of memory dies within a memory system in accordance with examples as disclosed herein. The timing diagram 400 may implement, or be implemented by, one or more aspects of the system 100, the memory system 200, and the memory device 300. For example, the timing diagram 400 illustrates a set of signals 405-a communicated between a host system and a buffer chip included in a memory device (e.g., a memory package, a DRAM package), which may be examples of corresponding devices described with reference to FIGS. 1-3. Additionally, the timing diagram 400 illustrates a set of signals 405-b communicated between the buffer chip and one or more memory dies included in the memory device (e.g., a set of stacked memory dies included in a memory package), which may be examples of corresponding devices described with reference to FIGS. 2 and 3. In some cases, the timing diagram 400 may support the buffer chip receiving a 3DS command from the host system (e.g., an access command shown by the set of signals 405-a) and routing information included in the 3DS command to the one or more memory dies (e.g., forwarding information according to the set of signals 405-b), which may reduce a capacitive load at a data bus between the host system and a memory system including the memory device.

In some cases, the host system may issue a 3DS command to the memory system. For example, the 3DS command may include an access command indicating to access (e.g., read data from or write data to) a memory die of the memory system. As described herein, the memory system may include multiple memory devices, where each memory device may be an example of a memory package including a set of multiple stacked memory dies. Additionally, each memory device may include a buffer chip coupled with a data bus and a CA bus between the host system and the memory system and coupled with a respective set of memory dies in a corresponding package.

The set of signals 405-a may include signals sent from the host system to a first memory device of the memory system. For example, the set of signals 405-a may represent information included in a 3DS command, such as a QCK 410 (e.g., an external clock signal associated with the host system), a QCS 415 (e.g., one or more CS signals), a QCA 420 (e.g., CA information associated with the 3DS command, which may include bits CA[13:0]), and a CID 425 (e.g., bits corresponding to relatively high-order CA bits, such as CA[13:11]). The QCS 415 may include a first CS signal indicating that the first memory device is selected (e.g., from the memory devices included in the memory system). The QCS 415 may be referred to as a first CS signal or a second CS signal, in some examples described herein. In some examples, the QCA 420 may indicate two sets of CA bits according to the value of the QCS 415. For example, the QCA 420 may indicate a first set of CA bits (e.g., CA[13:0]) for reception at a set of CA pins at the buffer chip when the QCS 415 transitions to a first value (e.g., goes low as illustrated by the timing diagram 400) and the QCA 420 may indicate a second set of CA bits (e.g., CA[13:0]) for reception at the set of CA pins when the QCS 415 transitions to a second value (e.g., goes high as illustrated by the timing diagram 400). Additionally, or alternatively, the CID 425 may indicate respective bits of the CID signal according to the value of the QCS 415. For example, the CID 425 may indicate a first portion of the CID when the QCS 415 transitions to the first value (e.g., CID [2:0] corresponding to CA[13:11] of the first set of CA bits) and the CID 425 may indicate a second portion of the CID when the QCS 415 transitions to the second value (e.g., CID3 corresponding to CA13 of the second set of CA bits).

The set of signals 405-b may include signals sent from the buffer chip to the set of stacked memory dies included in a corresponding memory device (e.g., memory dies of the first memory device selected by the 3DS command). For example, the buffer chip may forward a CK 430 to each memory die (e.g., forwarding the external clock signal associated with the host system) and may forward a CA 435 to each memory die (e.g., forwarding the CA information of the 3DS command to each memory die). In some examples, the buffer chip may use the CID information included in the CID 425 to determine which memory die of the memory device is being accessed by the 3DS command. For example, the buffer chip may determine that a first memory die is being accessed, and may output a second CS signal to the first memory die via a CS 440-a (e.g., a CS pin coupled between the first memory die and the buffer chip). Due to selecting the first memory die from the set of memory dies, other memory dies of the memory device may not receive the second CS signal. For example, a CS 440-b associated with a pin coupled between the buffer chip and a second memory die may remain at an unselected value (e.g., remain high), a CS 440-c associated with a pin coupled between the buffer chip and a third memory die may remain at the unselected value, and a CS 440-d associated with a pin coupled between the buffer chip and a fourth memory die may remain at the unselected value. The CS signals output from the buffer chip to the memory die(s) may be referred to as a second CS signal or a first CS signal in some examples described herein.

In some examples, the buffer chip may identify which memory die to output the second CS signal to based on a mapping between the memory dies of the memory device and the CID bits, the first CS signal, or both. For example, the buffer chip may include two CS pins (e.g., CS₀ and CS₁) the buffer chip may receive the first CS signal at one of the two CS pins. In some cases, the buffer chip may identify that the first memory die is being accessed based on which CS pin the first CS signal is received at as well as a value of one of the CID bits. For example, when selecting between four memory dies as illustrated by the timing diagram 400, the buffer chip may identify that the first memory die is being accessed based on receiving the first CS signal at a first CS pin and a value of CID2 in the CID 425 (e.g., as described in greater detail with reference to FIG. 3). Additionally, or alternatively, when selecting between greater quantities of memory dies (e.g., if the memory device includes eight memory dies or sixteen memory dies), the buffer chip may use values of additional CID bits (e.g., CID [1:0]) to determine which memory die to output the second CS signal to. In some examples, the QCS 415 may include a third CS signal (e.g., the buffer chip may receive a CS signal at each of the two CS pins), and the buffer chip may determine which memory die to output the second CS signal based on one or both of the first CS signal and the third CS signal. Based on receiving the second CS signal, the first memory die may receive data signals included in the 3DS command to facilitate access of the first memory die.

Such techniques may enable the buffer chip to route a 3DS command to the memory dies of the memory device and select individual ones of the memory dies for accessing, which may support the memory device being associated with a single capacitive load at the data bus between the host system and the memory system, thereby improving signal integrity, transfer speeds, and overall performance of a memory system including multiple memory devices.

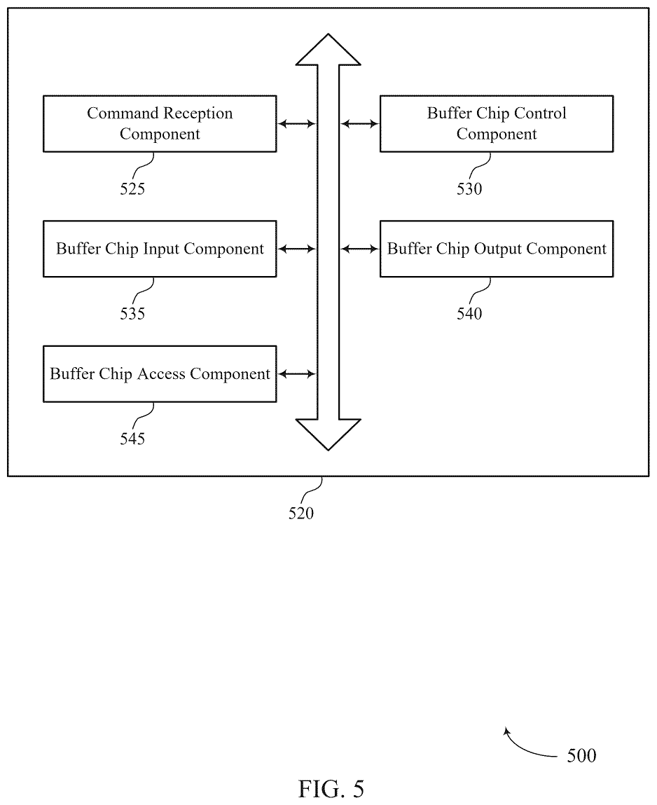

FIG. 5 shows a block diagram 500 of a memory system 520 that supports a buffer chip for routing CA and data signals to a stack of memory dies within a memory system in accordance with examples as disclosed herein. The memory system 520 may be an example of aspects of a memory system as described with reference to FIGS. 1 through 4. The memory system 520, or various components thereof, may be an example of means for performing various aspects of a buffer chip for routing CA and data signals to a stack of memory dies within a memory system as described herein. For example, the memory system 520 may include a command reception component 525, a buffer chip control component 530, a buffer chip input component 535, a buffer chip output component 540, a buffer chip access component 545, or any combination thereof. Each of these components, or components of subcomponents thereof (e.g., one or more processors, one or more memories), may communicate, directly or indirectly, with one another (e.g., via one or more buses).

The command reception component 525 may be configured as or otherwise support a means for receiving, via a bus coupled with a plurality of memory devices of a memory system, an access command associated with a first memory device of the plurality of memory devices, where the access command includes a first CS signal and a chip identifier signal associated with a first memory die of a plurality of memory dies stacked within the first memory device, the first memory device including a buffer chip coupled with the bus and the plurality of memory dies. The buffer chip control component 530 may be configured as or otherwise support a means for activating, by the buffer chip, a second CS signal for selection of the first memory die based on the chip identifier signal and the first CS signal indicated via the access command, the second CS signal associated with a CS pin coupled with the first memory die and the buffer chip. In some examples, the buffer chip control component 530 may be configured as or otherwise support a means for accessing, by the buffer chip, the first memory die in accordance with the second CS signal and the access command.

In some examples, to support activating the second CS signal, the buffer chip control component 530 may be configured as or otherwise support a means for determining, by the buffer chip, whether the first CS signal is received at a first CS input of the buffer chip or a second CS input of the buffer chip, or both. In some examples, to support activating the second CS signal, the buffer chip control component 530 may be configured as or otherwise support a means for activating, by the buffer chip, the second CS signal for selection of the first memory die based on whether the first CS signal is received at the first CS input, or the second CS input, or both and based on a value of a CA bit included in the access command, the CA bit associated with the chip identifier signal.

In some examples, the buffer chip input component 535 may be configured as or otherwise support a means for receiving, by the buffer chip via the bus, the access command including CA information, a clock signal, the first CS signal, and a third CS signal. In some examples, the buffer chip output component 540 may be configured as or otherwise support a means for outputting, via one or more first output pins of the buffer chip coupled with the plurality of memory dies, the CA information and the clock signal to each memory die of the plurality of memory dies via. In some examples, the buffer chip output component 540 may be configured as or otherwise support a means for outputting, via the CS pin coupled with the buffer chip and the first memory die, the second CS signal to the first memory die based on one or both of the first CS signal and the third CS signal received by the buffer chip.

In some examples, the buffer chip input component 535 may be configured as or otherwise support a means for receiving, at the buffer chip and via the bus, data associated with the access command, the access command including a write command that indicates the data to be written to the first memory die. In some examples, the buffer chip control component 530 may be configured as or otherwise support a means for routing, by the buffer chip, the data from the bus to the first memory die based on one or more CA bits included in the write command and based on activation of the second CS signal for selection of the first memory die.

In some examples, to support accessing the first memory die, the buffer chip access component 545 may be configured as or otherwise support a means for reading, by the buffer chip, data within the first memory die based on the access command including a read command that indicates to retrieve the data from the first memory die. In some examples, to support accessing the first memory die, the buffer chip control component 530 may be configured as or otherwise support a means for routing, by the buffer chip, the data to the bus in response to the read command and based on activation of the second CS signal for selection of the first memory die.

In some examples, the buffer chip output component 540 may be configured as or otherwise support a means for forwarding, by the buffer chip, a plurality of CA bits indicated via the access command to each memory die of the plurality of memory dies.

In some examples, the buffer chip output component 540 may be configured as or otherwise support a means for forwarding, by the buffer chip, a clock signal indicated via the access command to each memory die of the plurality of memory dies.

In some examples, the described functionality of the memory system 520, or various components thereof, may be supported by or may refer to a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

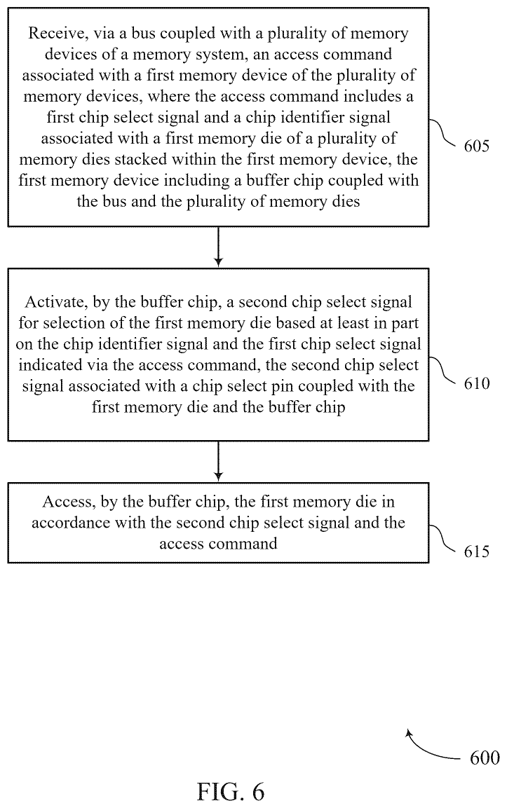

FIG. 6 shows a flowchart illustrating a method 600 that supports a buffer chip for routing CA and data signals to a stack of memory dies within a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, via a bus (e.g., the bus 225, the bus 310-a) coupled with a plurality of memory devices (e.g., memory devices 145, packages 210), of a memory system, an access command associated with a first memory device of the plurality of memory devices, where the access command includes a first CS signal (e.g., QCS 415) and a chip identifier signal (e.g., CID 425) associated with a first memory die of a plurality of memory dies (e.g., memory dies 215, 315) stacked within the first memory device, the first memory device including a buffer chip (e.g., the buffer chip 160, 220, 305) coupled with the bus and the plurality of memory dies. In some examples, aspects of the operations of 605 may be performed by a command reception component 525 as described with reference to FIG. 5.

At 610, the method may include activating, by the buffer chip, a second CS signal (e.g., one of the CS 440-a, 440-b, 440-c, and 440-d) for selection of the first memory die based on the chip identifier signal and the first CS signal indicated via the access command, the second CS signal associated with a CS pin coupled with the first memory die and the buffer chip. In some examples, aspects of the operations of 610 may be performed by a buffer chip control component 530 as described with reference to FIG. 5.

At 615, the method may include accessing, by the buffer chip, the first memory die in accordance with the second CS signal and the access command. In some examples, aspects of the operations of 615 may be performed by a buffer chip control component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, via a bus coupled with a plurality of memory devices of a memory system, an access command associated with a first memory device of the plurality of memory devices, where the access command includes a first CS signal and a chip identifier signal associated with a first memory die of a plurality of memory dies stacked within the first memory device, the first memory device including a buffer chip coupled with the bus and the plurality of memory dies; activating, by the buffer chip, a second CS signal for selection of the first memory die based on the chip identifier signal and the first CS signal indicated via the access command, the second CS signal associated with a CS pin coupled with the first memory die and the buffer chip; and accessing, by the buffer chip, the first memory die in accordance with the second CS signal and the access command.
Aspect 2: The method, apparatus, or non-transitory computer-readable medium of aspect 1, where activating the second CS signal includes operations, features, circuitry, logic, means, or instructions, or any combination thereof for determining, by the buffer chip, whether the first CS signal is received at a first CS input of the buffer chip or a second CS input of the buffer chip, or both and activating, by the buffer chip, the second CS signal for selection of the first memory die based on whether the first CS signal is received at the first CS input, or the second CS input, or both and based on a value of a CA bit included in the access command, the CA bit associated with the chip identifier signal.
Aspect 3: The method, apparatus, or non-transitory computer-readable medium of any of aspects 1 through 2, further including operations, features, circuitry, logic, means, or instructions, or any combination thereof for receiving, by the buffer chip via the bus, the access command including CA information, a clock signal, the first CS signal, and a third CS signal; outputting, via one or more first output pins of the buffer chip coupled with the plurality of memory dies, the CA information and the clock signal to each memory die of the plurality of memory dies; and outputting, via the CS pin coupled with the buffer chip and the first memory die, the second CS signal to the first memory die based on one or both of the first CS signal and the third CS signal received by the buffer chip.
Aspect 4: The method, apparatus, or non-transitory computer-readable medium of any of aspects 1 through 3, further including operations, features, circuitry, logic, means, or instructions, or any combination thereof for receiving, at the buffer chip and via the bus, data associated with the access command, the access command including a write command that indicates the data to be written to the first memory die, where accessing the first memory die includes routing, by the buffer chip, the data to the first memory die based on one or more CA bits included in the write command and based on activation of the second CS signal for selection of the first memory die.
Aspect 5: The method, apparatus, or non-transitory computer-readable medium of any of aspects 1 through 4, where accessing the first memory die includes operations, features, circuitry, logic, means, or instructions, or any combination thereof for reading, by the buffer chip, data within the first memory die based on the access command including a read command that indicates to retrieve the data from the first memory die and routing, by the buffer chip, the data to a host system via the bus in response to the read command and based on activation of the second CS signal for selection of the first memory die.
Aspect 6: The method, apparatus, or non-transitory computer-readable medium of any of aspects 1 through 5, further including operations, features, circuitry, logic, means, or instructions, or any combination thereof for forwarding, by the buffer chip, a plurality of CA bits indicated via the access command to each memory die of the plurality of memory dies.
Aspect 7: The method, apparatus, or non-transitory computer-readable medium of any of aspects 1 through 6, further including operations, features, circuitry, logic, means, or instructions, or any combination thereof for forwarding, by the buffer chip, a clock signal indicated via the access command to each memory die of the plurality of memory dies.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 8: A memory system, including: an input/output buffer configured to receive a plurality of access commands from a host system coupled with the input/output buffer; a data bus coupled with the input/output buffer; and one or more memory devices coupled with the data bus, where each memory device of the one or more memory devices includes a respective buffer chip and a respective set of memory dies stacked in a vertical direction over the respective buffer chip, and where a first buffer chip of a first memory device of the one or more memory devices is configured to: receive an access command, of the plurality of access commands, that corresponds to the first memory device including the first buffer chip, the access command indicating to access a first memory die of a first set of memory dies included in the first memory device; and output, to the first memory die via a CS pin coupled with the first memory die and the first buffer chip, a first CS signal for selection of the first memory die based on the access command.
Aspect 9: The memory system of aspect 8, where the first buffer chip includes a first CS input pin and a second CS input pin, and where, to output the first CS signal via the CS pin, the first buffer chip is configured to: activate the first CS signal based on whether a second CS signal received with the access command is received at the first CS input pin, the second CS input pin, or both.
Aspect 10: The memory system of aspect 9, where the first buffer chip is further configured to: select the first memory die from the first set of memory dies based on whether the first CS signal is received at the first CS input pin, the second CS input pin, or both, and further based on a CA bit included in the access command.
Aspect 11: The memory system of any of aspects 8 through 10, where the first buffer chip is further configured to: determine that the access command corresponds to the first memory device including the first buffer chip based on a chip identifier signal included in the access command, the chip identifier signal including a plurality of bits indicating the first memory device from the one or more memory devices.

An apparatus is described. The following provides an overview of aspects of the apparatus as described herein:
Aspect 12: A buffer chip, including: one or more CA pins configured to receive a three-dimensional stacked command that indicates to access a first memory die of a plurality of stacked memory dies coupled with the buffer chip; a first CS input pin and a second CS input pin, where the first CS input pin, the second CS input pin, or both are configured to receive a CS signal associated with the three-dimensional stacked command; a plurality of CS output pins each coupled with a respective memory die of the plurality of stacked memory dies and configured to activate the respective memory die based on information received via the one or more CA pins, the first CS input pin, the second CS input pin, or any combination thereof; and one or more data pins configured to transfer data associated with the three-dimensional stacked command between the plurality of stacked memory dies and a host system via the buffer chip based on the plurality of CS output pins.
Aspect 13: The buffer chip of aspect 12, further including: logic circuitry configured to: forward the three-dimensional stacked command to each memory die of the plurality of stacked memory dies via one or more output CA pins of the buffer chip.
Aspect 14: The buffer chip of any of aspects 12 through 13, further including: a multiplexer configured to: multiplex the data based on CA information received via the one or more CA pins; and forward the data to the first memory die of the plurality of stacked memory dies based on the multiplexing and the CA information associated with the first memory die.
Aspect 15: The buffer chip of any of aspects 12 through 14, further including: a first-in-first-out queue configured to: receive the information via the one or more CA pins, the first CS input pin, the second CS input pin, or any combination thereof; and forward the three-dimensional stacked command to each memory die of the plurality of stacked memory dies based on receipt of the information, the information including CA information and one or more CS signals associated with the three-dimensional stacked command.
Aspect 16: The buffer chip of any of aspects 12 through 15, further including: a decoder circuit configured to output a second CS signal to the first memory die of the plurality of stacked memory dies via a first CS output pin of the plurality of CS output pins, where the first CS output pin is selected based on which of the first CS input pin or the second CS input pin receives the CS signal and further based on a chip identifier bit included in the information received by the one or more CA pins.
Aspect 17: The buffer chip of any of aspects 12 through 16, further including: a multiplexer; and logic circuitry coupled with the multiplexer and configured to: receive the information via the one or more CA pins, the first CS input pin, and the second CS input pin; and output a selection signal to the multiplexer based on the information, where the multiplexer is configured to output the data to the first memory die of the plurality of stacked memory dies based on the selection signal selecting a first output of the multiplexer that is associated with the first memory die.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

The terms “layer” and “level” may refer to an organization (e.g., a stratum, a sheet) of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, or materials. In some examples, one layer or level may be composed of two or more sublayers or sublevels.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a plurality of memory devices; and
processing circuitry coupled with the plurality of memory devices and configured to cause the memory system to:
receive, via a bus coupled with the plurality of memory devices, an access command associated with a first memory device of the plurality of memory devices, wherein the access command comprises a first chip select signal and a chip identifier signal associated with a first memory die of a plurality of memory dies stacked within the first memory device, the first memory device comprising a buffer chip coupled with the bus and the plurality of memory dies;
activate, by the buffer chip, a second chip select signal for selection of the first memory die based on the chip identifier signal and the first chip select signal indicated via the access command, the second chip select signal associated with a chip select pin coupled with the first memory die and the buffer chip; and
access, by the buffer chip, the first memory die in accordance with the second chip select signal and the access command.

2. The memory system of claim 1, wherein, to activate the second chip select signal, the processing circuitry is configured to cause the memory system to:
determine, by the buffer chip, whether the first chip select signal is received at a first chip select input of the buffer chip or a second chip select input of the buffer chip, or both; and
activate, by the buffer chip, the second chip select signal for selection of the first memory die based on whether the first chip select signal is received at the first chip select input, or the second chip select input, or both and based on a value of a command/address bit included in the access command, the command/address bit associated with the chip identifier signal.

3. The memory system of claim 1, wherein the processing circuitry is further configured to cause the memory system to:
receive, by the buffer chip via the bus, the access command comprising command/address information, a clock signal, the first chip select signal, and a third chip select signal;
output, via one or more first output pins of the buffer chip coupled with the plurality of memory dies, the command/address information and the clock signal to each memory die of the plurality of memory dies via; and
output, via the chip select pin coupled with the buffer chip and the first memory die, the second chip select signal to the first memory die based on one or both of the first chip select signal and the third chip select signal received by the buffer chip.

4. The memory system of claim 1, wherein the processing circuitry is further configured to cause the memory system to:
receive, at the buffer chip and via the bus, data associated with the access command, the access command comprising a write command that indicates the data to be written to the first memory die, wherein, to access the first memory die, the processing circuitry is configured to cause the memory system to:
route, by the buffer chip, the data to the first memory die based on one or more command/address bits included in the write command and based on activation of the second chip select signal for selection of the first memory die.

5. The memory system of claim 1, wherein, to access the first memory die, the processing circuitry is configured to cause the memory system to:
read, by the buffer chip, data within the first memory die based on the access command comprising a read command that indicates to retrieve the data from the first memory die; and
route, by the buffer chip, the data to a host system via the bus in response to the read command and based on activation of the second chip select signal for selection of the first memory die.

6. The memory system of claim 1, wherein the processing circuitry is further configured to cause the memory system to:
forward, by the buffer chip, a plurality of command/address bits indicated via the access command to each memory die of the plurality of memory dies.

7. The memory system of claim 1, wherein the processing circuitry is further configured to cause the memory system to:
forward, by the buffer chip, a clock signal indicated via the access command to each memory die of the plurality of memory dies.

8. A memory system, comprising:
an input/output buffer configured to receive a plurality of access commands from a host system coupled with the input/output buffer;
a data bus coupled with the input/output buffer; and
one or more memory devices coupled with the data bus, wherein each memory device of the one or more memory devices comprises a respective buffer chip and a respective set of memory dies stacked in a vertical direction over the respective buffer chip, and wherein a first buffer chip of a first memory device of the one or more memory devices is configured to:
receive an access command, of the plurality of access commands, that corresponds to the first memory device including the first buffer chip, the access command indicating to access a first memory die of a first set of memory dies included in the first memory device; and
output, to the first memory die via a chip select pin coupled with the first memory die and the first buffer chip, a first chip select signal for selection of the first memory die based on the access command.

9. The memory system of claim 8, wherein the first buffer chip comprises a first chip select input pin and a second chip select input pin, and wherein, to output the first chip select signal via the chip select pin, the first buffer chip is configured to:
activate the first chip select signal based on whether a second chip select signal received with the access command is received at the first chip select input pin, the second chip select input pin, or both.

10. The memory system of claim 9, wherein the first buffer chip is further configured to:
select the first memory die from the first set of memory dies based on whether the second chip select signal is received at the first chip select input pin, the second chip select input pin, or both, and further based on a command/address bit included in the access command.

11. The memory system of claim 8, wherein the first buffer chip is further configured to:
determine that the access command corresponds to the first memory device including the first buffer chip based on a chip identifier signal included in the access command, the chip identifier signal comprising a plurality of bits indicating the first memory device from the one or more memory devices.

12. A buffer chip, comprising:
one or more command/address pins configured to receive a three-dimensional stacked command that indicates to access a first memory die of a plurality of stacked memory dies coupled with the buffer chip;
a first chip select input pin and a second chip select input pin, wherein the first chip select input pin, the second chip select input pin, or both are configured to receive a chip select signal associated with the three-dimensional stacked command;
a plurality of chip select output pins each coupled with a respective memory die of the plurality of stacked memory dies and configured to activate the respective memory die based on information received via the one or more command/address pins, the first chip select input pin, the second chip select input pin, or any combination thereof; and
one or more data pins configured to transfer data associated with the three-dimensional stacked command between the plurality of stacked memory dies and a data path via the buffer chip based on the plurality of chip select output pins.

13. The buffer chip of claim 12, further comprising:
logic circuitry configured to:
forward the three-dimensional stacked command to each memory die of the plurality of stacked memory dies via one or more output command/address pins of the buffer chip.

14. The buffer chip of claim 12, further comprising:
a multiplexer configured to:
multiplex the data based on command/address information received via the one or more command/address pins; and
forward the data to the first memory die of the plurality of stacked memory dies based on multiplexing the data and the command/address information associated with the first memory die.

15. The buffer chip of claim 12, further comprising:
a first-in-first-out queue configured to:
receive the information via the one or more command/address pins, the first chip select input pin, the second chip select input pin, or any combination thereof; and
forward the three-dimensional stacked command to each memory die of the plurality of stacked memory dies based on receipt of the information, the information comprising command/address information and one or more chip select signals associated with the three-dimensional stacked command.

16. The buffer chip of claim 12, further comprising:
a decoder circuit configured to output a second chip select signal to the first memory die of the plurality of stacked memory dies via a first chip select output pin of the plurality of chip select output pins, wherein the first chip select output pin is selected based on which of the first chip select input pin or the second chip select input pin receives the chip select signal and further based on a chip identifier bit included in the information received by the one or more command/address pins.

17. The buffer chip of claim 12, further comprising:
a multiplexer; and
logic circuitry coupled with the multiplexer and configured to:
receive the information via the one or more command/address pins, the first chip select input pin, and the second chip select input pin; and
output a selection signal to the multiplexer based on the information, wherein the multiplexer is configured to output the data to the first memory die of the plurality of stacked memory dies based on the selection signal selecting a first output of the multiplexer that is associated with the first memory die.

18. A method, comprising:
receiving, via a bus coupled with a plurality of memory devices of a memory system, an access command associated with a first memory device of the plurality of memory devices, wherein the access command comprises a first chip select signal and a chip identifier signal associated with a first memory die of a plurality of memory dies stacked within the first memory device, the first memory device comprising a buffer chip coupled with the bus and the plurality of memory dies;
activating, by the buffer chip, a second chip select signal for selection of the first memory die based on the chip identifier signal and the first chip select signal indicated via the access command, the second chip select signal associated with a chip select pin coupled with the first memory die and the buffer chip; and
accessing, by the buffer chip, the first memory die in accordance with the second chip select signal and the access command.

19. The method of claim 18, wherein activating the second chip select signal comprises:
determining, by the buffer chip, whether the first chip select signal is received at a first chip select input of the buffer chip or a second chip select input of the buffer chip, or both; and
activating, by the buffer chip, the second chip select signal for selection of the first memory die based on whether the first chip select signal is received at the first chip select input, or the second chip select input, or both and based on a value of a command/address bit included in the access command, the command/address bit associated with the chip identifier signal.

20. The method of claim 18, further comprising:
receiving, by the buffer chip via the bus, the access command comprising command/address information, a clock signal, the first chip select signal, and a third chip select signal;
outputting, via one or more first output pins of the buffer chip coupled with the plurality of memory dies, the command/address information and the clock signal to each memory die of the plurality of memory dies via; and
outputting, via the chip select pin coupled with the buffer chip and the first memory die, the second chip select signal to the first memory die based on one or both of the first chip select signal and the third chip select signal received by the buffer chip.

21. The method of claim 18, further comprising:
receiving, at the buffer chip and via the bus, data associated with the access command, the access command comprising a write command that indicates the data to be written to the first memory die, wherein accessing the first memory die comprises:
routing, by the buffer chip, the data to the first memory die based on one or more command/address bits included in the write command and based on activation of the second chip select signal for selection of the first memory die.

22. The method of claim 18, wherein accessing the first memory die comprises:
reading, by the buffer chip, data within the first memory die based on the access command comprising a read command that indicates to retrieve the data from the first memory die; and
routing, by the buffer chip, the data to a host system via the bus in response to the read command and based on activation of the second chip select signal for selection of the first memory die.

23. The method of claim 18, further comprising:
forwarding, by the buffer chip, a plurality of command/address bits indicated via the access command to each memory die of the plurality of memory dies.

24. The method of claim 18, further comprising:
forwarding, by the buffer chip, a clock signal indicated via the access command to each memory die of the plurality of memory dies.

25. A non-transitory computer-readable medium storing code comprising instructions which, when executed by processing circuitry of an electronic device, cause the electronic device to:
receive, via a bus coupled with a plurality of memory devices of a memory system, an access command associated with a first memory device of the plurality of memory devices, wherein the access command comprises a first chip select signal and a chip identifier signal associated with a first memory die of a plurality of memory dies stacked within the first memory device, the first memory device comprising a buffer chip coupled with the bus and the plurality of memory dies;
activate, by the buffer chip, a second chip select signal for selection of the first memory die based on the chip identifier signal and the first chip select signal indicated via the access command, the second chip select signal associated with a chip select pin coupled with the first memory die and the buffer chip; and
access, by the buffer chip, the first memory die in accordance with the second chip select signal and the access command.

26. The non-transitory computer-readable medium of claim 25, wherein the instructions to activate the second chip select signal, when executed by the processing circuitry, cause the electronic device to:
determine, by the buffer chip, whether the first chip select signal is received at a first chip select input of the buffer chip or a second chip select input of the buffer chip, or both; and
activate, by the buffer chip, the second chip select signal for selection of the first memory die based on whether the first chip select signal is received at the first chip select input, or the second chip select input, or both and based on a value of a command/address bit included in the access command, the command/address bit associated with the chip identifier signal.

27. The non-transitory computer-readable medium of claim 25, wherein the instructions, when executed by the processing circuitry, further cause the electronic device to:
receive, by the buffer chip via the bus, the access command comprising command/address information, a clock signal, the first chip select signal, and a third chip select signal;
output, via one or more first output pins of the buffer chip coupled with the plurality of memory dies, the command/address information and the clock signal to each memory die of the plurality of memory dies via; and
output, via the chip select pin coupled with the buffer chip and the first memory die, the second chip select signal to the first memory die based on one or both of the first chip select signal and the third chip select signal received by the buffer chip.

28. The non-transitory computer-readable medium of claim 25, wherein the instructions, when executed by the processing circuitry, further cause the electronic device to:
receive, at the buffer chip and via the bus, data associated with the access command, the access command comprising a write command that indicates the data to be written to the first memory die, wherein the instructions to access the first memory die, when executed by the processing circuitry, cause the electronic device to:
route, by the buffer chip, the data to the first memory die based on one or more command/address bits included in the write command and based on activation of the second chip select signal for selection of the first memory die.

29. The non-transitory computer-readable medium of claim 25, wherein the instructions to access the first memory die, when executed by the processing circuitry, cause the electronic device to:
read, by the buffer chip, data within the first memory die based on the access command comprising a read command that indicates to retrieve the data from the first memory die; and
route, by the buffer chip, the data to a host system via the bus in response to the read command and based on activation of the second chip select signal for selection of the first memory die.

30. The non-transitory computer-readable medium of claim 25, wherein the instructions, when executed by the processing circuitry, further cause the electronic device to:
forward, by the buffer chip, a plurality of command/address bits indicated via the access command to each memory die of the plurality of memory dies.
